(19) United States
(12) Patent Application Publication
(10) Pub. No.: US 2010/0328017 A1
(43) Pub. Date: Dec. 30, 2010

(54) Current and temperature overloading protection device

(76) Inventor: Chin-Chi Yang, Wufong Hsiang (TW)

Correspondence Address: BACON & THOMAS, PLLC, 625 SLATERS LANE, FOURTH FLOOR, ALEXANDRIA, VA, 22314-1176, US

(21) Appl. No.: 12/458,054

(22) Filed: Jun. 30, 2009

(51) Int. Cl. H01H 85/20

(52) U.S. Cl. 337/186

(57) ABSTRACT

A current and temperature overloading protection device has a brace, a thermal sensing contact, a soldering layer, two ports and two resilient elements. The thermal sensing contact, the soldering layer, the two ports and the two resilient elements are mounted on the brace, where each resilient element is bent to connect between respective ports and the thermal soldering layer. The current and temperature overloading protection device is mounted on a circuit board to connecting a circuit loop of the circuit board, and the thermal sensing contact is connected to a heat-generating device. Therefore, the current and temperature overloading protection device provides protections to the circuit loop from thermal and current overloading issues.

### BACKGROUND OF THE INVENTION

1. Field of Invention

The present invention relates to an electric current overloading protection device, and more particular to a protection device that is also capable of detecting and preventing circuit failure due to high temperature.

2. Description of the Related Art

With reference to FIG. 5, an overloading protection device used for an electric circuit board has a brace (90), two ports (92), a temperature sensing element (93), a knife-break switch (94), and a current overload fuse (96). The two ports (92) are separately mounted on the brace (90). The temperature sensing element (93) is a rod made from a high thermal expansion material and is mounted between the ports (92). The knife-break switch (94) is mounted between the two ports (92) and has a pivotal end and a distal end. The distal end of the knife-break switch (94) selectively contacts one of the ports (92). The pivotal end of the knife-break switch (94) is electronically connected to the other port (92) with using the current overload fuse (96). During use, the over loading protection device is electronically connected in a circuit loop with the ports (92) and the temperature sensing element (93) is attached to a heat generating element of the circuit loop. Thus, the over loading protection device may break thus to protect the circuit loop either when temperature abnormally increases or when the current overloads.

Although the aforementioned overloading protection device may provide the circuit loop with the high temperature and overloaded current protection, the overloading protection device still has disadvantages. For instance, an installation angle of the overloading protection device is limited since the knife-break switch cannot function up side down. Moreover, many elements are required in the overloading protection device, thus manufacturing complexity and costs are not satisfactory.

The present invention provides a current and temperature overloading protection device that has a simplified structure without limitation to installation orientation.

### SUMMARY OF THE INVENTION

The primary objective of the present invention is to provide a current and temperature overloading protection device that is simple to manufacture without limitation to installation orientation.

The current and temperature overloading protection device has a brace, a thermal sensing contact, a soldering layer, two ports and two resilient elements. The thermal sensing contact, the soldering layer, the two ports and the two resilient elements are respectively mounted on the brace, where each resilient element is bent to connect between one of the ports and the thermal soldering layer. The current and temperature overloading protection device is mounted on a circuit board to connect with a circuit loop of the circuit board, and the thermal sensing contact is connected to a heat-generating device. Therefore, the current and temperature overloading protection device provides protections to the circuit loop from thermal and current overloading issues.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a current and temperature overloading protection device in accordance with the present invention;

FIG. 2 is a cross sectional side view of the current and temperature overloading protection device in FIG. 1, shown open;

FIG. 3 is a cross sectional side view of the current and temperature overloading protection device in FIG. 1, shown closed;

FIG. 4 is an operational top view of the current and temperature overloading protection device in FIG. 1; and

FIG. 5 is a perspective view of a conventional overloading protection device in accordance with the prior art.

### DETAILED DESCRIPTION OF THE INVENTION

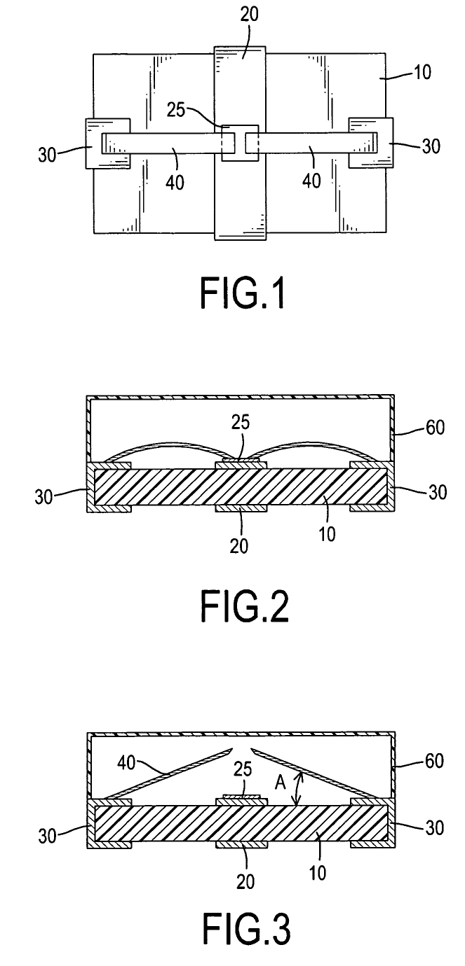

With reference to FIGS. 1, 2 and 3, a current and temperature overloading protection device in accordance with the present invention comprises a brace (10), a thermal sensing contact (20), a soldering layer (25), two ports (30), two resilient elements (40) and may have a cover (60).

The brace (10) is non-conductive, may be a printed circuit board (PCB), a plastic disc, a ceramic disc or the like and has a top surface and a bottom surface.

The thermal sensing contact (20) is thermally conductive and is mounted on the top and bottom surface of the brace (10). The thermal sensing contact (20) may be mounted through the brace (10), thereby contacting the top and bottom surfaces of the brace (10), or may be a band-like thermal conductible material that is mounted around the brace (10).

The soldering layer (25) is sheet like, is electrically conductive, is low temperature melting and is mounted on the thermal sensing contact (20) corresponding to the top surface of the brace (10). The soldering layer (25) may be Tin or Tin-alloy, which has a relatively low melting temperature at around 250 to 400 degrees centigrade.

The two ports (30) are electrically conductive, are mounted on the top and bottom surfaces of the brace (10) and are separated from the thermal sensing contact (20).

The two resilient elements (40) are electrically conductive, are rod-like, maybe made of stainless steel, copper, copper-alloy or the like and each resilient element (40) has two ends. The resilient elements (40) are bent and the ends of the resilient elements (40) are respectively mounted on and electronically connected to the soldering layer (25) and respective ports (30). Thus, the ports (30) are electronically connected to each other by the resilient elements (40) and the soldering layer (25). When the soldering layer (25) melts, one end of each resilient element (40) is released from the soldering layer (25) so the resilient elements (40) extend and disconnect the two ports (30).

The cover (60) is non-conductive, is shaped corresponding to the brace (10) and covers the top surface of the brace (10) to protect elements on the top layer of the brace (10).

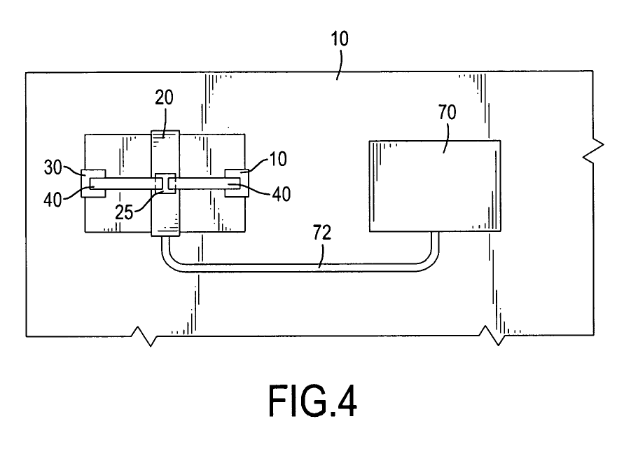

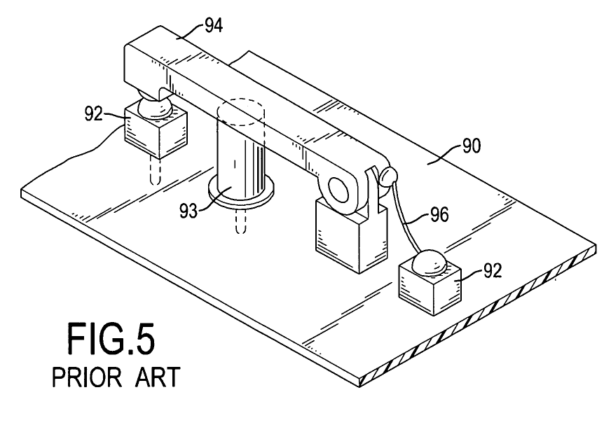

As described above, the disclosed current and temperature overloading protection device is a kind of a surface mount device (SMD). Therefore, the ports (30) on the bottom surface of the brace (10) may be mounted on a circuit board so as to be connected with a circuit loop in the circuit board. With reference to FIG. 4, the thermal sensing contact (20) is allocated adjacent to or directly contacts to a heat-generating element (70) of the circuit board or may be connected to the heat-generating element (70) through a heat pipe (72). Thus, the current and temperature overloading protection device is capable of protecting the circuit loop from failure due to thermal burn out or current overloading, since the soldering layer (25) melts by the heat generated from the heat-generating element (70) or the current passing therethrough.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A current and temperature overloading protection device comprising
a brace made of a non-conductive material and having a top surface and a bottom surface;
a thermal sensing contact made of a thermally conductive material and mounted on the top and bottom surfaces of the brace;
an electrically conductive soldering layer, mounted on the thermal sensing contact at a position corresponding to the top surface of the brace;
two ports made of an electrically conductive material, mounted on the top and bottom surfaces of the brace and separated from the thermal sensing contact; and
two resilient elements made of an electrically conductive material and each resilient element having two ends, wherein each resilient element is bent and the ends of the resilient element are mounted on and electronically connected to the soldering layer and a respective one of the ports.

2. The current and temperature overloading protection device as claimed in claim 1 further having a cover made of a non-conductive material, shaped corresponding to the brace and covering the top surface of the brace.

3. The current and temperature overloading protection device as claimed in claim 1, wherein the brace is a printed circuit board, a plastic disc or a ceramic disc.

4. The current and temperature overloading protection device as claimed in claim 2, wherein the brace is a printed circuit board, a plastic disc or a ceramic disc.

5. The current and temperature overloading protection device as claimed in claim 4, wherein the thermal sensing contact is a band-like thermal conductible material that is mounted around the brace and contacts the top and bottom surfaces of the brace.

6. The current and temperature overloading protection device as claimed in claim 4, wherein the soldering layer is made of Tin or Tin-alloy.

7. The current and temperature overloading protection device as claimed in claim 4, wherein the resilient elements are made of stainless steel, copper or copper-alloy.

8. The current and temperature overloading protection device as claimed in claim 6, wherein the resilient elements are made of stainless steel, copper or copper-alloy.
